(19) United States
(12) Patent Application Publication
(10) Pub. No.: US 2004/0091159 A1
(43) Pub. Date: May 13, 2004

(54) Image compression device and method for performing a frame skipping process

(75) Inventor: Tetsu Takahashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/685,463

(22) Filed: Oct. 16, 2003

(30) Foreign Application Priority Data
Oct. 18, 2002 (JP) 2002-303895

(51) Int. Cl. G06K 9/36; G06K 9/46

(52) U.S. Cl. 382/236; 382/238

(57) ABSTRACT

In an image compression device and method, an encoding unit which performs predictive coding of an input video sequence having a plurality of frames is provided. First frames at predetermined intervals in the input video sequence are left to cause the encoding unit to perform predictive coding of the first frames. Second frames which lie between two of the first frames in the input video sequence are discarded to cause the encoding unit to skip each second frame and perform predictive coding of a corresponding one of the first frames immediately preceding the second frame. Only encoded data of the first frames created by the encoding unit in association with the leaving step is outputted as a result of the predictive coding of the entire input video sequence.

### CROSS-REFERENCE TO RELATED APPLICATIONS

This application is based upon and claims the benefit of priority from the prior Japanese patent application No. 2002-303895, filed on Oct. 18, 2002, the entire contents of which are incorporated herein by reference.

### BACKGROUND OF THE INVENTION

1. Field of the Invention

The present invention relates to an image compression technique for use in recording, reproducing or displaying devices which carry out digital signal processing. More particularly, the present invention relates to an image compression device and method which performs a frame skipping process when carrying out image compression of an input stream by the MPEG1 or MPEG2 algorithm, in order to efficiently perform image coding with a small amount of codes and reduce the quantity of stored information.

2. Description of the Related Art

In recent years, in a supervisory monitoring system which performs digital signal processing, a recording and storing device which compresses a captured audio/video signal by using the compression technique, such as MPEG or MOTION_JPEG, and stores the compressed digital data into a recording medium, such as a hard disk drive (HDD), has been put into practical use.

In such situations, it is demanded to provide a system which is capable of recording and reproducing an image as long time as possible with the use of a hard disk drive having a specifically given storage capacity.

Generally, it is said that the quantity of compressed data produced by the MPEG1 or MPEG2 video technique is smaller than the quantity of compressed data produced by the MOTION_JPEG technique with respect to an image of the same level of picture quality. For this reason, in the viewpoint of reduction of the amount of information, the MPEG technique is more advantageous.

On the other hand, the compressed data produced by the MOTION_JPEG technique contains the information that is independent of respective frames, the reduction of the amount of information is easily attained by skipping some frames contained in the compressed data.

However, when the MPEG1/2 video technique is used, the compressed data contains the frames which must be decoded with reference to other frames. There is the problem in that the reduction of the amount of information cannot be easily attained by skipping some frames contained in the compressed data produced by the MPEG1/2 video technique.

In the encoding and decoding of motion picture, the predictive motion picture encoding is a basic technique which gives a significant effect to high compression of motion picture and is important for the encoding of motion picture.

However, the reference frame which has been used for the predictive encoding must be already decoded prior to the decoding of the predictive-coded picture signal. Therefore, in order to realize the random access function which can obtain arbitrary picture frames, and to obtain a single decoded picture signal, it is necessary to decode a number of frames in the motion picture. For this reason, the processing overhead of the MPEG technique becomes large and the handling is inconvenient.

In the case of the MPEG algorithm, in order to satisfy the requirements of high compression ratio and random access function, the encoding is performed by classifying the pictures contained in a video sequence into the following three types:

(1) Intra-Coded Pictures

Hereinafter, the pictures of this type are called I pictures for the sake of convenience of description. I pictures do not use the information on other pictures, but are encoded only for the information on their own pictures similar to the JPEG technique. (2) Predictive-Coded Pictures

Hereinafter, the pictures of this type are called P pictures for the sake of convenience of description. P pictures are subjected to the forward predictive motion picture coding on the time axis by using a previous I picture or previous P picture as the reference frame.

(3) Bidirectionally Predictive-Coded Pictures

Hereinafter, the pictures of this type are called B pictures for the sake of convenience of description. B pictures are subjected to the forward and backward predictive motion picture coding on the time axis by using previous and future I pictures or previous and future P pictures as the reference frames.

I pictures have a low compression ratio, and they can be decoded independently with other pictures and are used as an access point at the time of random access.

P pictures have a compression ratio that is higher than that of I pictures. However, the decoding of P pictures requires the information on the previous I pictures on the time axis.

B pictures have the highest compression ratio among the three types. However, the decoding of B pictures requires the information on the previous and future I pictures or P pictures on the time axis.

Moreover, the decoding of the future P pictures must be done prior to the decoding of B pictures, and when displaying the decoded B pictures, the delay takes place.

In the MPEG standards, the method of composition of these three picture types in the image encoding/decoding is a matter of the encoder. Hence, the user can choose any of the compression ratio, the random access function, and the delay time as being the preferential matter in accordance with the applications.

The incoming video sequence (the input video signal), which is inputted to the MPEG encoder, is divided into individual pictures each of which is a particular one of the three picture types of I pictures, P pictures and B pictures. Among these, the video signal of P pictures and B pictures is used to calculate the difference with the motion prediction signal which is derived from the reference picture. Hereinafter, the difference between the input video signal and the motion prediction signal is called the prediction difference signal.

In order to use the spatial redundancy first, the DCT transformation of the prediction difference signal is performed. Next, the information that is of small importance is removed by performing the quantization which is the irreversible process. The zigzag scanning of the quantized DCT coefficients is carried out, and variable length coding is carried out with added information, such as the motion vector, etc., and it is stored at an appropriate position of the bit stream. This coding processing of the MPEG algorithm from the DCT transformation to the variable length coding is essentially the same as that of the JPEG method, although the coding parameters differ a little.

FIG. 2 is a diagram for explaining an image compression method which performs a conventional frame skipping process. For example, Japanese Laid-Open Patent Application No. 11-177986 discloses a similar image compression method.

In the conventional frame skipping process of FIG. 2, the case in which the input video signal (video sequence) is encoded in IBBPBB format by the MPEG2 encoder and multiplexing processing is carried out is considered.

In the case of FIG. 2, the MPEG2 encoder performs the frame skipping process so that the first picture A (I picture) and the fourth picture D (P picture) are left while the second and third pictures B and C and the fifth and sixth pictures E and F are discarded. The prediction coding of the fourth picture D (P picture) using the first picture A (I picture) as the reference frame is possible.

The first, fourth and seventh pictures A, D and G, which correspond to the respective times of picture change, are subjected to decoding on the time according to the PTS (picture time stamp) of each picture, and the decoded image data is displayed. For example, suppose the case where the video signal in the example of FIG. 2 is encoded at equal intervals of 30 frame/sec. In the case, each code data of the first, fourth and seventh pictures A, D and G, which are left as a result of the frame skipping process, is decoded at equal intervals of 10 frame/sec, and the decoded image data is displayed.

The input video signal inputted to the MPEG encoder contains the frames (P picture, B picture) that must be subjected to the prediction coding with reference to other frames (I picture, P picture). Thus, the conventional system which performs the image compression of the digital signal by the MPEG1/2 video technique has the problem in that the frame skipping process cannot be simply performed for the input video signal.

Therefore, the amount of information created through the image compression in the case of the conventional system is large, and it is difficult for the conventional system to perform recording and reproducing with a hard disk drive having a predetermined storage capacity for a long time.

### SUMMARY OF THE INVENTION

An object of the present invention is to provide an improved image compression device and method in which the above-described problems are eliminated.

Another object of the present invention is to provide an image compression device which efficiently encodes the digital signal in a smaller amount of codes and enables reduction of the amount of stored information without changing the conventional encoding method significantly, by skipping predetermined frames in the input video sequence in the MPEG1/2 video format prior to the image compression of the video sequence.

Another object of the present invention is to provide an image compression method which efficiently encodes the digital signal in a smaller amount of codes and enables reduction of the amount of stored information without changing the conventional encoding method significantly, by skipping predetermined frames in the input video sequence in the MPEG1/2 video format prior to the image compression of the video sequence.

The above-mentioned objects of the present invention are achieved by an image compression device comprising: an encoding unit which performs predictive coding of an input video sequence having a plurality of frames; a first unit which leaves first frames at predetermined intervals in the input video sequence to cause the encoding unit to perform predictive coding of the first frames; a second unit which discards second frames, which lie between two of the first frames in the input video sequence, to cause the encoding unit to skip each second frame and perform predictive coding of a corresponding one of the first frames immediately preceding the second frame; and an output unit which outputs only encoded data of the first frames created by the encoding unit in association with the first unit as a result of the predictive coding of the entire input video sequence.

The above-mentioned objects of the present invention are achieved by an image compression method comprising the steps of: leaving first frames at predetermined intervals in an input video sequence having a plurality of frames to cause an encoding unit to perform predictive coding of the first frames, the encoding unit performing predictive coding of the input video sequence; discarding second frames, which lie between two of the first frames in the input video sequence, to cause the encoding unit to skip each second frame and perform predictive coding of a corresponding one of the first frames immediately preceding the second frame; and outputting only encoded data of the first frames created by the encoding unit in association with the leaving step as a result of the predictive coding of the entire input video sequence.

According to the image compression device and method of the present invention, it is possible to skip the predetermined frames in the input video sequence in the MPEG1/2 video format without changing the conventional encoding method significantly. The image compression device and method of the present invention enables reduction of the amount of stored information with low cost. Therefore, if the image compression device and method of the present invention are applied to an image encoding/decoding system, the amount of the compressed video signal when it is stored in a hard disk drive having a predetermined storage capacity can be reduced with low cost.

### BRIEF DESCRIPTION OF THE DRAWINGS

Other objects, features and advantages of the present invention will be apparent from the following detailed description when read in conjunction with the accompanying drawings.

FIG. 1 is a diagram for explaining the principle of the image compression method according to the present invention.

FIG. 2 is a diagram for explaining the principle of a conventional image compression technique.

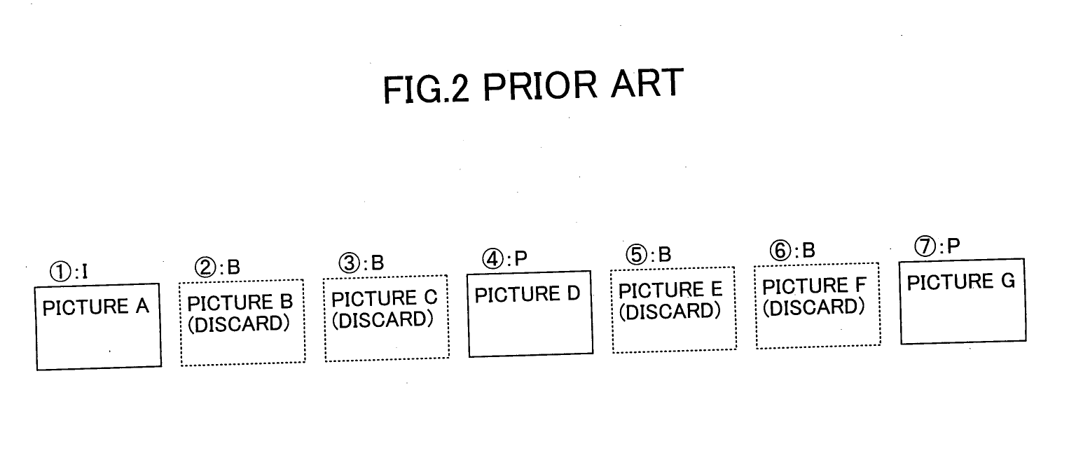

FIG. 3 is a diagram for explaining the data structure of a video sequence in the MPEG1/2 video format.

FIG. 4 is a block diagram of an image encoding/decoding system to which one embodiment of the image compression device of the present invention is applied.

FIG. 5 is a block diagram for explaining the flow of a video signal in the image encoding/decoding system of FIG. 4.

FIG. 6 is a flowchart for explaining a frame skipping process performed by one embodiment of the image compression device of the present invention.

### DETAILED DESCRIPTION OF PREFERRED EMBODIMENTS

A description will now be given of preferred embodiments of the present invention with reference to the accompanying drawings.

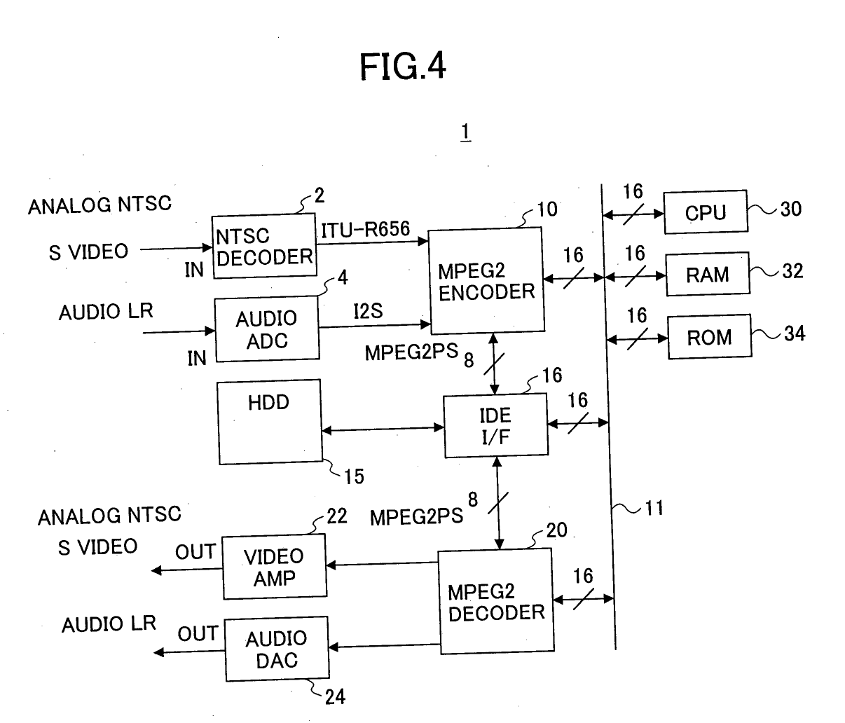

FIG. 4 shows an image encoding/decoding system to which one embodiment of the image compression device of the present invention is applied.

As shown in FIG. 4, the image encoding/decoding system 1 comprises an NTSC (National Television System Committee) decoder 2, an audio ADC (analog-to-digital converter) 4, an MPEG2 encoder 10, a system bus 11, a HDD (hard disk drive) 15, an IDE (integrated device electronics) interface 16, a video amplifier 22, an audio DAC (digital-to-analog converter) 24, an MPEG2 decoder 20, a CPU 30, a RAM 32, and a ROM 34.

The image encoding/decoding system 1 of FIG. 4 has two major functions. One major function is the recording function which encodes the input analog AV (audio/video) signal by using the MPEG2 encoder 10, and records the compressed data in the hard disk drive 15. The other function is the reproducing function which reads out the compressed data from the hard disk drive 15, decodes the compressed data by using the MPEG2 decoder 20, and outputs the reconstructed analog AV signal.

In the image encoding/decoding system 1 of FIG. 4, the encoding/decoding processing of MPEG2 video format is performed, and the format of compressed data is MPEG2_PS. However, the present invention is not limited to this embodiment, and the present invention may be applied to an image encoding/decoding system using MPEG1 video format or other format.

A description will be given of the flow of the signal processing by the image encoding/decoding system 1 of FIG. 4 flows.

First, the flow of the signal processing when the recording function is carried out will be described.

The input analog video signal (NTSC_S_VIDEO) is sent to the NTSC decoder 2. The received input signal is transformed into the digital signal of ITU-R656 format by the NTSC decoder 2. The transformed video signal is delivered from the NTSC decoder 2 to the MPEG2 encoder 10.

The input analog audio signal (AUDIO_LR) is sent to the audio ADC 4. The received input signal is transformed into the digital signal of 12S format by the audio ADC 4. The transformed audio signal is delivered from he audio ADC 4 to the MPEG2 encoder 10.

In the MPEG2 encoder 10, the video signal is encoded in the MPEG2 video MP@ML format, and the audio signal is encoded in the MPEG1 audio layer 2 format.

Furthermore, multiplexing processing of both the encoded data of the video signal and the audio signal is carried out by the multiplexing processing unit (which will be described later) in the encoded data of MPEG2_PS format.

The encoded data (stream) of MPEG2_PS format is delivered from the 8-bit output port of the MPEG2 encoder 10 to the IDE interface 16. Further, the encoded data of MPEG2_PS format is sent to the hard disk drive (HDD) 15 through the IDE interface 16, so that it is stored in the hard disk drive 15.

Next, the flow of the signal processing when the reproducing function is carried out by the image encoding/decoding system 1 of FIG. 4 will be described.

The encoded data (stream) stored in the hard disk drive 15 is read out by the MPEG2 decoder 20 through the IDE interface 16. In the MPEG2 decoder 20, demultiplexing processing of the read-out encoded data (MPEG2_PS format) is carried out, and the read-out encoded data is separated into the encoded data of MPEG2 video MP@ML format and the code data of MPEG1 audio layer 2 format.

Moreover, in the MPEG2 decoder 20, the encoded data (MPEG2 video MP@ML format) is decoded into the MPEG2 video signal, and it is further converted to the video signal of NTSC format. The MPEG2 decoder 20 outputs this video signal to the video amplifier (AMP) 22.

Moreover, in the MPEG2 decoder 20, the encoded data of MPEG1 audio layer 2 format is decoded into the audio signal of 12S format. The MPEG2 decoder 20 outputs this audio signal to the audio DA converter (DAC) 24.

The video amplifier 22 amplifies the inputted video signal of NTSC format, and outputs the analog video signal (NTSC_S_VIDEO). The audio DA converter 24 converts the inputted audio signal of 12S format and outputs the analog audio signal (AUDIO_LR). The output AV signals are sent to and reproduced by an external reproducing system (not shown).

The image encoding/decoding system 1 of FIG. 4 is configured so that the MPEG2 encoder 10, the IDE interface 16, and the MPEG2 decoder 20 are interconnected by the 16-bit system bus 11, and the transferring of 16-bit data between the CPU 30, the RAM 32 and the ROM 34 is attained through the system bus 11.

Next, a description will be given of the function of the IDE interface 16 in the image encoding/decoding system 1 of FIG. 4.

The IDE interface 16 has the function which carries out the DMA (Direct Memory Access) transfer of the encoded data (stream) of the MPEG2_PS format from the 8-bit output port of the MPEG2 encoder 10 to the hard disk drive 15. Starting, stopping and addressing of the DMA transfer function of the IDE interface 16 are attained by using the register setting by the CPU 30.

The IDE interface 16 has the function which carries out the DMA transfer of the encoded data (stream) stored in the hard disk drive 15, to the MPEG2 decoder 20. Starting, stopping and addressing of this DMA transfer function are also attained by using the register setting by the CPU 30.

The CPU 30 and the IDE interface 16 are interconnected by the system bus 11, which allows the CPU 30 to access a predetermined address of the hard disk drive 15 through the IDE interface 16.

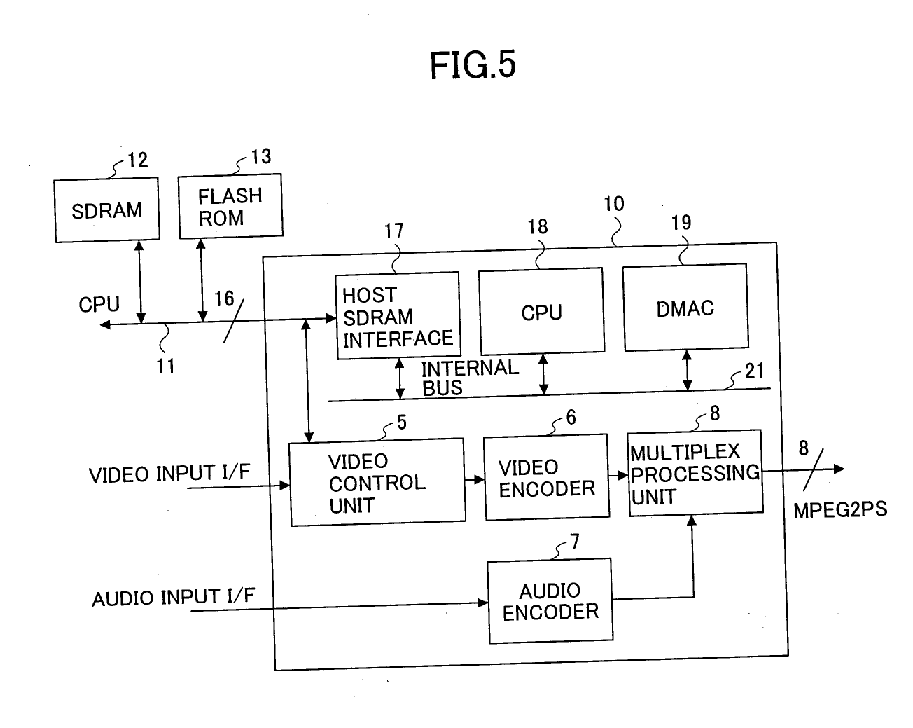

FIG. 5 shows the flow of the video signal in the MPEG2 encoder 10 of the image encoding/decoding system of FIG. 4.

As shown in FIG. 5, the image encoding/decoding system of FIG. 4 further includes an SDRAM (synchronous dynamic random-access memory) 12 and a flash ROM 13 both connected to the system bus 11. The MPEG2 encoder 10 comprises a video control unit 5, a video encoder 6, an audio encoder 7, a multiplexing processing unit 8, an SDRAM interface 17, a CPU 18, a DMAC (direct memory access controller) 19, and an internal bus 21.

The input video signal to the MPEG2 encoder 10 is written to the SDRAM 12 through the video control unit 5. The SDRAM 12 may be provided outside the MPEG2 encoder 10 as shown in FIG. 5. Alternatively, the SDRAM 12 may be provided within the MPEG2 encoder 10. The video signal is read out from the SDRAM 12, and it is delivered to the video encoder 6 through the video control unit 5. In the video encoder 6, the received video signal is encoded in the MPEG2 video MP@ML format.

The input audio signal to the MPEG2 encoder 10 is delivered to the audio encoder 7. In the audio encoder 7, the received audio signal is encoded in the MPEG1 audio layer 2 format.

The multiplexing processing unit 8 carries out multiplexing processing of the encoded data of the MPEG2 video MP@ML format from the video encoder 6 and the encoded data of the MPEG1 audio layer 2 format from the audio encoder 7, and generates the encoded data (stream) of the MPEG2_PS format.

The encoded data of the MPEG2_PS format is outputted to the IDE interface 16 from the 8-bit output port of the MPEG2 encoder 10.

As shown in FIG. 5, the SDRAM interface 17, the CPU 18, and the DMA controller 19 are provided in the MPEG2 encoder 10, and these units are interconnected by the internal bus 21. Furthermore, the SDRAM interface 17 is connected to the 16-bit system bus 11. Therefore, the CPU 18 is allowed to access a predetermined address of the SDRAM 12 through the SDRAM interface 17.

The DMA controller 19 controls the DMA transfer processing in which the data is directly transmitted between the HDD 15 and the SDRAM 12, without being controlled by the CPU 18.

Moreover, the flash ROM 13 is connected to the system bus 11 and used to store the program for causing the CPU 18 to execute the frame skipping process of the present invention (which will be described later). Alternatively, the program for causing the CPU 18 to execute the frame skipping process of the present invention may be stored in the ROM 34.

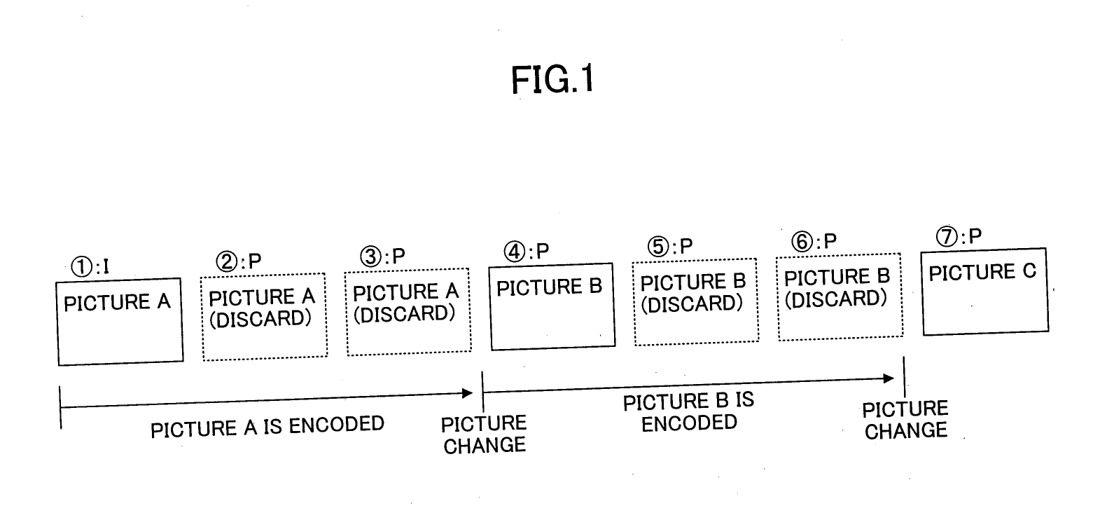

FIG. 1 is a diagram for explaining the principle of the image compression method which performs the frame skipping process according to the present invention.

In the frame skipping process of FIG. 1, suppose the case in which the input video signal (video sequence) is encoded in the IPPP format by the MPEG2 encoder 10, and the multiplexing processing is carried out by the MPEG2 encoder 10.

In the frame skipping process of FIG. 1, the MPEG2 encoder 10 performs the frame skipping process so that the first picture A (I picture) and the fourth picture B (P picture) are left while the second and third pictures and the fifth and sixth pictures are discarded. The encoded data of the fourth picture B inherently cannot be decoded with no reference to the third picture preceding the fourth picture B. All the preceding pictures (the first through third pictures) are encoded from the same picture A. Hence, the prediction coding of the fourth picture B (P picture) using the first picture A (I picture) as the reference frame is possible.

The first, fourth and seventh pictures A, B and C, which correspond to the respective times of picture change, are subjected to decoding on the time according to the PTS (picture time stamp) of each picture, and the decoded image data is displayed. For example, suppose the case where the video signal in the example of FIG. 1 is encoded at equal intervals of 30 frame/sec. In this case, each encoded data of the first, fourth and seventh pictures A, B and C, which are left as a result of the frame skipping process, is decoded at equal intervals of 10 frame/sec, and the decoded image data is displayed.

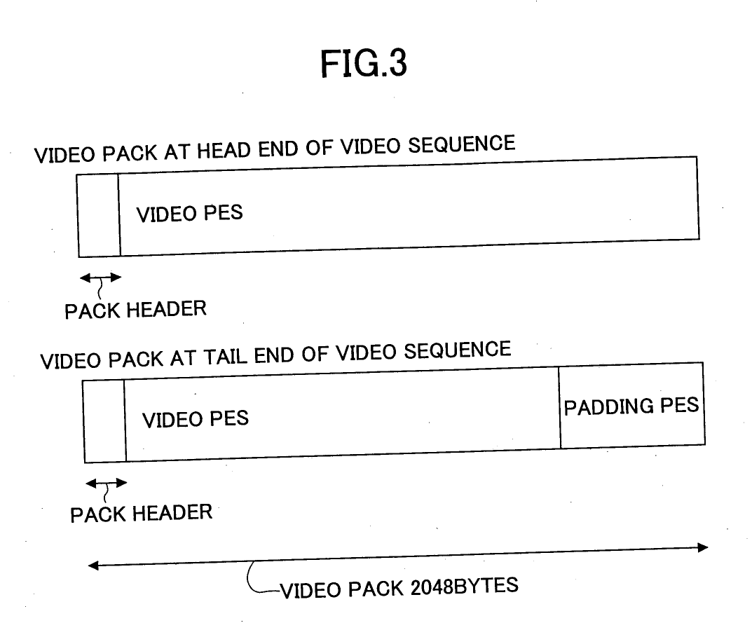

FIG. 3 shows the data structure of each picture frame in a video sequence in the MPEG1/2 video format.

Based on the MPEG1/2 video format, the video sequence inputted to the MPEG2 encoder includes the sequence header at the beginning of the video sequence, and the sequence end at the end thereof.

The sequence header contains information related to the whole video sequence, including size information indicating the size of the picture, frame-number information indicating the number of frames encoded per second, and rate information indicating the transmission speed.

Moreover, the video sequence is comprised of one or a plurality of GOP (group(s) of pictures). One GOP is comprised of a GOP header, and one or a plurality of pictures. The pictures in each of the plurality of GOP include I pictures (intra-coded pictures), P pictures (predictive-coded pictures) which require the information on the preceding I pictures on the time axis during the decoding, and B pictures (bidirectionally predictive-coded pictures) which require the information on the preceding and following I or P pictures on the time axis during the decoding. I picture is always inserted as the head-end picture for each of the plurality of GOP. The picture time stamp (PTS) information for enabling time matching with the audio data at the time of the image decompression is included in the GOP header.

In the MPEG encoder, the input video sequence is encoded as two or more video packs (PACK) which have the data structure as shown in FIG. 3. In the frame skipping process of the present invention, the skipping of the encoded data (stream) is performed per video pack, and the video pack in which the picture determined by the frame skipping is contained is skipped.

The number of pictures for each of the plurality of GOP contained in the input video stream is set to an arbitrary value.

As shown in FIG. 3, each video pack includes 2048 bytes of information, and is comprised of the pack header and the encoded data or video PES (packetized elementary stream).

The starting video PES is arranged in the video pack at the head end of each picture of the input video sequence. The padding PES is inserted in the video pack at the tail end of each picture of the input video sequence.

Moreover, one picture is equivalent to each one-screen image of one of the frames of the motion picture signal, and is constituted by one of the three picture types of I, P and B pictures.

The information for identifying a particular picture type among I, P and B pictures, and the information for specifying the display order of each picture is included in the picture header.

As described above, in the frame skipping process of the present invention, the skipping of the encoded data (stream) is performed per video pack, and the video pack in which the picture determined by the frame skipping process is contained is skipped. The number of pictures that are skipped continuously varies within the video stream. It means that the case where the number of pictures being skipped is equal to 0 is included for the frame skipping process of the present invention. As the encoding of the pictures skipped is not performed, the encoding of a corresponding one of the pictures left which immediately precedes the skipped picture is performed instead.

The MPEG2 encoder 10 may perform the frame skipping process of the present invention. Alternatively, a subsequent-stage system may perform the frame skipping process of the present invention. Moreover, a device for performing the encoding of a corresponding one of the pictures left which immediately precedes the skipped picture may be configured by either of the following two methods. One of them is that according to the sequence of the picture type (I, P, B) of each picture of the input video signal, the MPEG2 encoder 10 performs the encoding of the same picture for each skipped picture. The other method is that the MPEG2 encoder 10 discards the unnecessary pictures prior to the encoding of the input video signal, and then performs the encoding of the same picture.

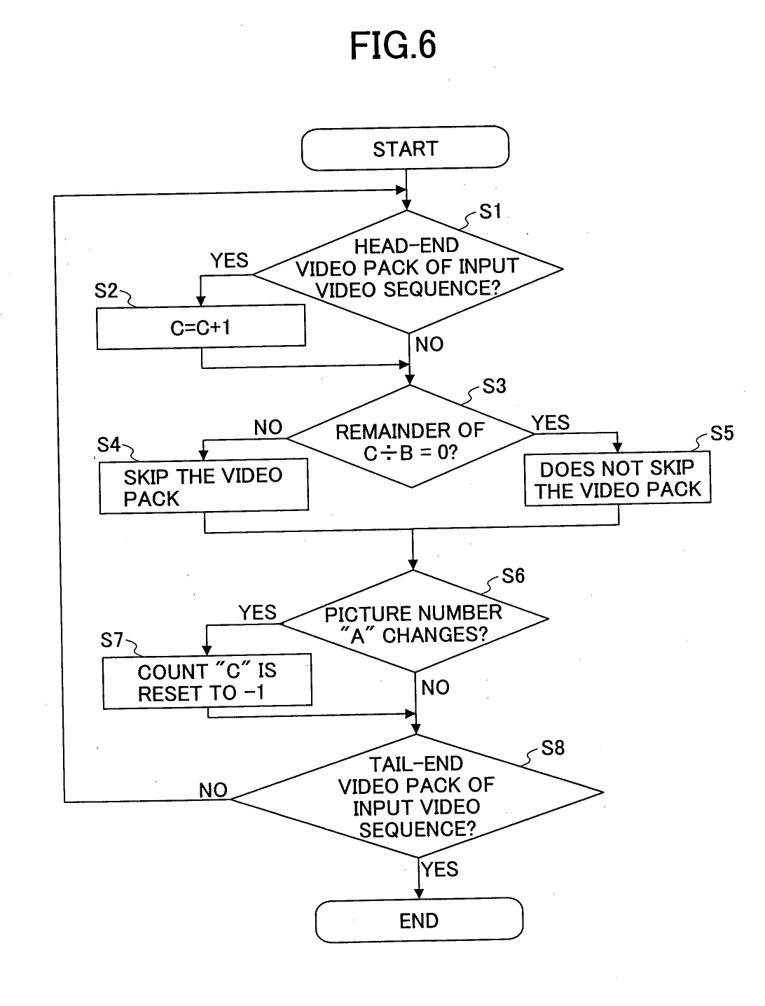

FIG. 6 is a flowchart for explaining the frame skipping process which is performed by one embodiment of the image compression device of the present invention.

The frame skipping process in the present embodiment is executed by the CPU 18 in the MPEG2 encoder 10 of FIG. 5. The CPU 18 performs the frame skipping process of FIG. 6 according to the program stored in the flash ROM 13.

Alternatively, it is also possible to configure the image compression device of the present invention so that the CPU 30 (which controls the MPEG2 encoder 10) performs the frame skipping process of FIG. 6 according to the program stored in the ROM 34.

In the frame skipping process of FIG. 6, the input video signal to the MPEG2 encoder 10 is encoded in the IPPP format.

Moreover, the input video signal is encoded based on the data structure of FIG. 3, and the frame skipping process is performed per video pack.

In the frame skipping process of FIG. 6, “A” (a positive integer) indicates the number of pictures in each GOP of the input video signal, “B” (a positive integer) indicates the interval at which the pictures are left, and “C” (an integer started from 1) indicates the count number from the head-end picture to the target picture. The handling of these parameters A, B and C in the frame skipping process of FIG. 6 is attained by using the register setting by the CPU 18.

Moreover, in the present embodiment, the parameter B (indicating the interval at which the pictures are left) is set to a predetermined value (a positive integer).

In the following description, the term “frame” is used in the same meaning as the picture (or video pack).

As shown in FIG. 6, when the encoding of the video encoder 6 is started, the CPU 18 reads out one frame of the input video sequence from the SDRAM 12. The CPU 18 determines whether the current video pack is the head-end video pack of the input video sequence based on the header information of the video pack included in the read frame (step S1).

When the result of the determination at step S1 is YES, the CPU 18 increments of the count number C (step S2). The CPU 18 performs the following step S3 after the increment of the count number C. As previously described, the initial value of the count number C is set to −1.

When the result of the determination at step S1 is NO, the CPU 18 calculates the division of the count number C with the value of the parameter B (the interval at which the pictures are left) and finds the remainder of the division, without incrementing the count number C. The CPU 18 determines whether the result of the calculation is equal to zero (step S3).

Namely, the CPU 18 performs the processing which leaves the target frame if the target frame is located at the predetermined interval in the input vide sequence. Otherwise the CPU 18 performs the processing which skips the target frame as in the example of FIG. 1.

When the result of the determination at step S3 is NO, the CPU 18 performs processing which skips the current video pack of the target frame and acquires the following video pack of the target frame (step S4).

When the result of the determination at step S3 is YES, the CPU 18 performs processing which leaves the current video pack of the target frame and acquires the following video pack of the target frame (step S5).

After one of the step S4 or the step S5 is completed, the CPU 18 determines whether the target frame becomes the headend picture of the next GOP and the picture number “A” of the current GOP is changed (step S6).

When the result of the determination at step S6 is YES, the CPU 18 resets the count number “C” to −1 (initial value) (step S7). After the step S7 is performed, the CPU 18 performs the following step S8.

When the result of the determination at step S6 is NO, the CPU 18 determines whether the target frame includes the header information which indicates the end of the input video sequence (step S8).

When the result of the determination at step S8 is YES, the CPU 18 terminates the frame skipping process of FIG. 6. At this time, the CPU 18 causes the video encoder 6 to perform the encoding of the processed video sequence, and then causes the multiplexing processing unit 8 to perform the multiplexing processing. Therefore, the MPEG2 encoder 10 outputs the encoded data after the above-described frame skipping process is performed, to the IDE interface 16 from the 8-bit output port of the MPEG2 encoder 10.

When the result of the determination at step S8 is NO, the CPU 18 repeats the above-mentioned processing of steps S1-S8 until the end of the input video signal is detected.

In the frame skipping process of the present embodiment, by controlling the video encoder 6, the CPU 18 serves to discard the frames, which lie between two of the frames being left in the input video sequence, and perform the predictive coding of a corresponding one of the frames being left immediately preceding the skipped frame. Then, the CPU 18 causes the video encoder 6 to output the encoded data to the multiplexing processing unit 8. As for the frames at the predetermined intervals (B) in the input video sequence, the CPU 18 serves to output the encoded data to the multiplexing processing unit 8 without skipping them.

By controlling the multiplexing processing unit 8, the CPU 18 serves to discard the encoded data of the frame skipped, and carries out multiplexing processing only of the encoded data of the frames left with the encoded data of the audio signal from the audio encoder 7.

As described in the foregoing, according to image compression device and method of the present invention, it is possible to skip the predetermined frames in the input video sequence in the MPEG1/2 video format without changing the conventional encoding method significantly. The image compression device and method of the present invention enables reduction of the amount of stored information with low cost. Therefore, if the image compression device and method of the present invention are applied to an image encoding/decoding system, the amount of the compressed video signal when it is stored in a hard disk drive having a specifically given storage capacity can be reduced with low cost.

The present invention is not limited to the above-described embodiments, and variations and modifications may be made without departing from the scope of the present invention.

What is claimed is:

1. An image compression device comprising:
an encoding unit performing predictive coding of an input video sequence having a plurality of frames;
a first unit leaving first frames at predetermined intervals in the input video sequence to cause the encoding unit to perform predictive coding of the first frames;
a second unit discarding second frames, which lie between two of the first frames in the input video sequence, to cause the encoding unit to skip each second frame and perform predictive coding of a corresponding one of the first frames immediately preceding the second frame; and
an output unit outputting only encoded data of the first frames created by the encoding unit in association with the first unit as a result of the predictive coding of the entire input video sequence.

2. The image compression device according to claim 1 wherein the first frames that are left are either intra-coded pictures or predictive-coded pictures contained in the input video sequence, and the second frames which are discarded are predictive-coded pictures contained in the input video sequence.

3. The image compression device according to claim 1 wherein the encoded data of the first frames created by the encoding unit is stored in a storage device having a predetermined storage capacity as a result of the predictive coding of the entire input video sequence.

4. The image compression device according to claim 1 wherein the encoding unit, the first unit, the second unit and the output unit are arranged in an MPEG2 encoder.

5. The image compression device according to claim 1 wherein the encoding unit and the output unit are arranged in an MPEG2 encoder, and the first unit and the second unit are arranged in an external control unit connected to the MPEG2 encoder.

6. An image compression method comprising the steps of:
leaving first frames at predetermined intervals in an input video sequence having a plurality of frames to cause an encoding unit to perform predictive coding of the first frames, said encoding unit performing predictive coding of the input video sequence;
discarding second frames, which lie between two of the first frames in the input video sequence, to cause the encoding unit to skip each second frame and perform predictive coding of a corresponding one of the first frames immediately preceding the second frame; and
outputting only encoded data of the first frames created by the encoding unit in association with the leaving step as a result of the predictive coding of the entire input video sequence.

7. The image compression method according to claim 6 wherein the first frames that are left are either intra-coded pictures or predictive-coded pictures contained in the input video sequence, and the second frames which are discarded are predictive-coded pictures contained in the input video sequence.

8. The image compression device according to claim 6 wherein the encoded data of the first frames created by the encoding unit is stored in a storage device having a predetermined storage capacity as a result of the predictive coding of the entire input video sequence.

9. The image compression method according to claim 6 wherein the encoding unit is arranged in an MPEG2 encoder, and the MPEG2 encoder performs the predictive coding, the leaving step, the discarding step and the outputting step.

10. The image compression method according to claim 6 wherein the encoding unit is arranged in an MPEG2 encoder so that the MPEG2 encoder performs the predictive coding and the outputting step, and an external control unit connected to the MPEG2 encoder is arranged so that the external control unit performs the leaving step and the discarding step.
